(19) United States
(12) Patent Application Publication
(10) Pub. No.: US 2005/0117825 A1
(43) Pub. Date: Jun. 2, 2005

(54) Wheel support bearing assembly with built-in sensor

(75) Inventors: Satoshi Goto, Iwata-shi (JP); Hisashi Otsuki, Iwata-shi (JP)

Correspondence Address: STAAS & HALSEY LLP, SUITE 700, 1201 NEW YORK AVENUE, N.W., WASHINGTON, DC, 20005, US

(73) Assignee: NTN CORPORATION, Osaka (JP)

(21) Appl. No.: 10/994,520

(22) Filed: Nov. 23, 2004

(30) Foreign Application Priority Data
Nov. 26, 2003 (JP) 2003-395353

(51) Int. Cl. F16C 41/04; F16C 32/00

(52) U.S. Cl. 384/448

(57) ABSTRACT

There is provided a wheel support bearing assembly which includes an outer member (1) having an inner peripheral surface formed with outer raceways (4), an inner member (2) having inner raceways (5) aligned with the respective outer raceways (4), and rows of rolling elements (3). The inner member (2) includes a hub axle (2A) and a raceway forming member (2B) mounted on an inboard end of the hub axle (2A). The inner raceways (5) are formed on an outer peripheral surface of the hub axle (2A) and an outer peripheral surface of the raceway forming member (2B), respectively. The bearing assembly also includes a ring-shaped to-be-detected element (9) mounted on a portion of the inner member (2) between the inner raceways (5) and having an outer diameter smaller than the diameter of the circle inscribed by the row of the rolling elements (3), and a sensor (10), for detecting the element (9), mounted on a corresponding portion of the outer member (1) between the outer raceways (4).

### BACKGROUND OF THE INVENTION

1. Field of the Invention

The present invention relates to a wheel support bearing assembly having a sensor built therein, such as a rotation detector.

2. Description of the Prior Art

A wheel support bearing assembly having a sensor such as a rotation detector is well known in the art. An example of the prior art wheel support bearing assemblies of the type referred to above is shown in FIG. 14A. As shown in FIG. 14A, the prior art wheel support bearing assembly such as disclosed in the Japanese Laid-open Patent Publication No. 62-249069 and the Japanese Utility Model Registration No. 2567498 includes an outer member 31 having an inner peripheral surface formed with two outer raceways 34, an inner member 32 positioned inside the outer member 31, with an annular bearing space defined between it and the outer member 31, and having an outer peripheral surface formed with inner raceways 35 in alignment with the respective outer raceways 34, and circumferential rows of rolling elements 33 rollingly received in part within the outer raceways 34 and in part within the inner raceways 35, respectively. A pulsar ring 39 is mounted on a portion of the inner member 32, which is an element rotatable relative to the outer member 31, between the inner raceways 35 for rotation together with the inner member 32 and, on the other hand, a magnetic sensor 40 for detecting the pulsar ring 39 is mounted on a corresponding portion of the outer member 31, which is an element stationary relative to the inner member 32, between the outer raceways 34 and in alignment with the path of travel of the pulsar ring 39.

The prior art wheel support bearing assembly shown in FIG. 14A is classified as a third generation type bearing assembly, in which the inner member 32 is made up of a hub axle 32A, having one of the inner raceways 35 defined in an outer peripheral surface thereof, and an inner race 32B having the other of the inner raceways 35 defined in an outer peripheral surface thereof and fixedly mounted on an inboard end of the hub axle 32A. The pulsar ring 39 and the magnetic sensor 40 cooperate with each other to define a rotation detector for detecting the number of revolutions of the inner member 32, which detector is utilized as a component part of the anti-skid brake system for controlling the automotive brake in reference to the speed of an automotive vehicle.

In most cases, the pulsar ring 39 has a series of serrations formed on an outer peripheral surface thereof and has therefore a substantial thickness. Because of this, as shown in FIG. 14B on an enlarged scale, the outer diameter B1 of the pulsar ring 39 tends to be greater than the diameter A1 of the circle inscribed by the circumferential row of the rolling elements 33 then rollingly interposed between the adjacent pair of the outer and inner raceways 34 and 35.

In view of the foregoing, assemblage of the prior art wheel support bearing assembly of the structure discussed above is generally carried out, following the sequence of assembling steps shown in FIGS. 15A to 17C.

(1) In the first place, as shown in FIG. 15A, the outboard rolling elements 33 retained by an outboard roller retainer 36 are inserted into one of the outer raceways 35, which is positioned on the outboard side.

(2) A quantity of grease, that is a lubricant, is then applied to an outboard portion of the inner peripheral surface of the outer member 31, including the outboard rolling element 33, as shown in FIG. 15B.

(3) An annular outboard sealing member 37 is press-fitted into an outboard end of the outer member 31 from the outboard side as shown in FIG. 15C.

(4) The hub axle 32A is inserted into a bore of the outer member 31 from the outboard side as shown in FIG. 16A.

(5) The pulsar ring 39 is press-fitted onto an outer peripheral surface of the hub axle 32A from an inboard side, opposite to the outboard side, as shown in FIG. 16B.

(6) After the press-fitting of the pulsar ring 39, the inboard rolling elements 33 retained by an inboard roller retainer 36 are inserted into the other of the outer raceways 35, which is positioned on the inboard side, as shown in FIG. 16C.

(7) A quantity of grease is then applied to an inboard portion of the inner peripheral surface of the outer member 31, including the inboard rolling elements 33, as shown in FIG. 17A.

(8) The inner race 32B is subsequently press-fitted onto the inboard end of the hub axle 32A from the inboard side until the retained rolling elements 33 on the inboard side are seated on the inner raceway 35 defined in the inner race 32B, as shown in FIG. 17B.

(9) Finally, an annular inboard sealing member 38 is thereafter press-fitted into an inboard end of the outer member 31 from the inboard side as shown in FIG. 17C.

As discussed above, the prior art wheel support bearing assembly of the above structure requires a relatively large number of assembling steps, accompanied by increase of the assembling cost. Also, when the pulsar ring 39 is press-fitted onto the hub axle 32A as shown in FIG. 16B, the lubricant grease applied to the outboard rolling elements 33 tends to be contaminated by dusts and dirt produced during the press-fitting of the pulsar ring 39 onto the hub axle 32A. In addition, since the pulsar ring 39, which forms a to-be-detected member, is press-fitted to a position enclosed by the outer member 31, it is difficult to detect deformation and cracks in the pulsar ring 39, which may occur during the press-fitting.

### SUMMARY OF THE INVENTION

In view of the foregoing, an object of the present invention is to provide an improved wheel support bearing assembly which, even though a ring-shaped element to be detected is mounted on an inner member and positioned generally intermediate between inner raceways formed on the inner member, can be assembled with a minimized number of assembling steps and, hence, at a reduced cost, and in which not only can damage occurring during the press-fitting of the ring-shaped element be easily detected, but also dusts and dirt generated during the press-fitting of the ring-shaped element can also be removed.

In order to accomplish these objects of the present invention, there is provided a wheel support bearing assembly, which includes an outer member having an inner peripheral surface formed with a plurality of, for example, two, outer raceways, an inner member positioned inside the outer member, with an annular bearing space defined between it and the outer member, and having inner raceways formed therein in alignment with the respective outer raceways, and outboard and inboard rows of rolling elements rollingly accommodated within the annular bearing space and sandwiched between the outer raceways and the inner raceways, respectively. The inner member is made up of a hub axle, which has a radially outwardly extending hub flange formed therein for securement of a vehicle wheel thereto, and a raceway forming member mounted fixedly on an inboard end of the hub axle. The inner raceways are formed on an outer peripheral surface of the hub axle and an outer peripheral surface of the raceway forming member, respectively.

The wheel support bearing assembly also includes a ring-shaped element to be detected (or a ring-shaped to-be-detected element, as hereinafter used) mounted fixedly on a portion of the inner member between the inner raceways and a sensor, for detecting the to-be-detected element, fixedly mounted on a corresponding portion of the outer member between the outer raceways. The ring-shaped to-be-detected element has an outer diameter smaller than the diameter of the circle inscribed by the row of the rolling elements assembled into the outer raceway in the outer member.

According to the present invention, the outer diameter of the ring-shaped to-be-detected element is smaller than the diameter of the circle inscribed by the row of the rolling elements. Accordingly, the hub axle having the ring-shaped to-be-detected element mounted thereon can be inserted into a bore of the outer member having the rows of the rolling elements incorporated therein. Hence, as compared with the assemblage of the prior art wheel support bearing assembly discussed hereinbefore, the number of assembling steps can advantageously be reduced, which leads to reduction in number of assembling facilities and the man-hour, resulting in reduction of the manufacturing cost.

Also, since the ring-shaped to-be-detected element is press-fitted onto the hub axle prior to the incorporation of the hub axle into the bore of the outer member, any damage to the ring-shaped to-be-detected element such as cracking and/or deformation, which would otherwise occur during the press-fitting of the ring-shaped to-be-detected element, can easily be detected. Similarly, dusts and dirt generated during the press-fitting of the ring-shaped to-be-detected element can also be removed.

In a preferred embodiment of the present invention, the ring-shaped to-be-detected element may comprise a pulsar ring having a magnetic characteristic varying in a direction circumferentially thereof and the sensor referred to above may be a magnetic sensor. The pulsar ring and the magnetic sensor cooperate with each other to define a rotation detector.

According to this feature, the magnetic sensor detects change in magnetic characteristic of the pulsar ring then rotating together with the inner member to detect the rotation of a wheel.

In another preferred embodiment of the present invention, the ring-shaped to-be-detected element may be made of a magnetostrictive material, in which case the sensor may comprise a torque detecting element for detecting a torque, working on the inner member, by detecting change in magnetic characteristic of the ring-shaped to-be-detected element. This feature is effective to allow the torque acting on the inner member then supporting the vehicle wheel to be detected.

In a further preferred embodiment of the present invention, the raceway forming member may be an inner race which, for example, forms a dedicated member for defining the inner raceway.

Also, in the practice of the present invention, the raceway forming member may be an outer race of a constant velocity universal joint. In this case, the inner member may be of a structure, in which a shaft portion of the outer race of the constant speed universal joint is press-fitted into the bore of the hub axle, with the inner raceways defined in an outer peripheral surface of the hub axle and an outer peripheral surface of a base end of the shaft portion of the outer race of the constant speed universal joint, respectively.

Regardless of whether the raceway forming member is the inner race, or the outer race of the constant speed universal joint, the ring-shaped to-be-detected element can have its outer diameter that is smaller than the diameter of the circle inscribed by the row of the rolling elements incorporated in the outer member.

Other features of the present invention will become clear from the following detailed description.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal sectional view of a wheel support bearing assembly according to a first preferred embodiment of the present invention;

FIG. 2 is a fragmentary sectional view showing, on an enlarged scale, an important portion of the wheel support bearing assembly enclosed by the circle C in FIG. 1;

FIG. 3 is a fragmentary front view showing a rotation detector employed in the wheel support bearing assembly;

FIGS. 4A to 4D are longitudinal sectional views showing different steps of assemblage of the wheel support bearing assembly, respectively;

FIGS. 5A to 5C are longitudinal sectional views showing remaining steps of assemblage of the wheel support bearing assembly, respectively;

FIG. 6 is a longitudinal sectional view of the wheel support bearing assembly according to a second preferred embodiment of the present invention;

FIG. 7 is a longitudinal sectional view of the wheel support bearing assembly according to a third preferred embodiment of the present invention;

FIG. 8 is a longitudinal sectional view of the wheel support bearing assembly according to a fourth preferred embodiment of the present invention;

FIG. 9 is a longitudinal sectional view of the wheel support bearing assembly according to a fifth preferred embodiment of the present invention;

FIG. 10 is a longitudinal sectional view of the wheel support bearing assembly according to a sixth preferred embodiment of the present invention;

FIG. 11 is a longitudinal sectional view of the wheel support bearing assembly according to a seventh preferred embodiment of the present invention;

FIG. 12A is a fragmentary side view of an upper portion of a ring-shaped to-be-detected element, which can be employed in the wheel support bearing assembly according to any one of the first to seventh embodiments of the present invention;

FIG. 12B is a front sectional view of the ring-shaped to-be-detected element;

FIG. 13 is a longitudinal sectional view of the wheel support bearing assembly according to the first embodiment of the present invention, showing the use of an electric power generator in place of the rotation detector employed therein;

FIG. 14A is a longitudinal sectional view of the prior art wheel support bearing assembly;

FIG. 14B is a fragmentary sectional view showing, on an enlarged scale, an important portion of the prior art wheel support bearing assembly shown in FIG. 14A;

FIGS. 15A to 15C are longitudinal sectional views showing first to third steps of assemblage of the prior art wheel support bearing assembly, respectively;

FIGS. 16A to 16C are longitudinal sectional views showing fourth to sixth steps of assemblage of the prior art wheel support bearing assembly, respectively; and

FIGS. 17A to 17C are longitudinal sectional views showing seventh to ninth steps of assemblage of the prior art wheel support bearing assembly, respectively.

### DETAILED DESCRIPTION OF THE EMBODIMENTS

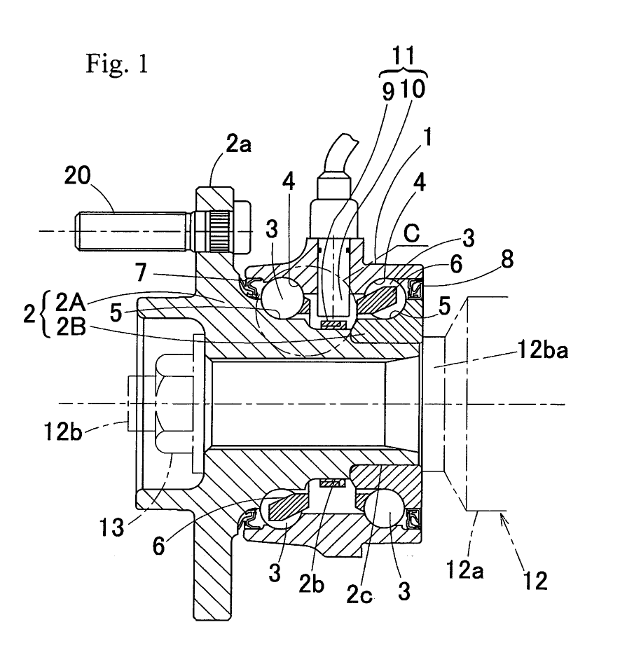

A wheel support bearing assembly according to a first preferred embodiment of the present invention will be described in detail with particular reference to FIGS. 1 to 5C. The wheel support bearing assembly shown therein is of an inner race rotating type of a third generation and is shown as utilized to support a vehicle drive wheel.

As shown in FIG. 1, the wheel support bearing assembly includes an outer member 1 having an inner peripheral surface formed with a plurality of, for example, first and second outer raceways 4, an inner member 2 positioned inside the outer member 1, with an annular bearing space defined between it and the outer member 1, and having first and second inner raceways 5 formed therein in alignment with the respective first and second outer raceways 4, and outboard and inboard rows of rolling elements 3 rollingly accommodated within the annular bearing space and rollingly sandwiched between the outer raceways 4 and the inner raceways 5, respectively. This wheel support bearing assembly is in the form of a dual row angular ball bearing assembly and, therefore, each of the raceways 4 and 5 represents a substantially circular sectional shape and the raceways 4 and 5 have their contact angles so defined as to achieve a back-to-back alignment or a symmetric contact. The rolling elements 3 of each row are employed in the form of a ball and are rollingly retained by a respective retainer 6.

The annular bearing space delimited between the inner and outer members 1 and 2 has inboard and outboard open ends opposite to each other, which are sealed by respective contact type sealing members 7 and 8 in any suitable manner known to those skilled in the art.

The outer member 1 is a single unitary component, which is fitted to a vehicle body structure (not shown) and serves as a stationary member. On the other hand, the inner member 2 serves as a member rotatable relative to the outer member 1 and is made up of a hub axle 2A, which has a radially outwardly extending hub flange 2a formed therein for securement of a vehicle wheel thereto, and a raceway forming member 2B mounted fixedly on an inboard end of the hub axle 2A.

Because of the inner member 2 being of the two component construction, the first inner raceway 5 is formed on an outer peripheral surface of the hub axle 2A, whereas the second inner raceway 5 is formed on an outer peripheral surface of the raceway forming member 2B. The raceway forming member 2B is an inner race dedicated for defining the second inner raceway 5. The hub axle 2A has an axial bore defined therein, into which a shaft portion 12b of an outer race 12 of a constant velocity universal joint is inserted and splined to the hub axle 2A for rotation together therewith.

The joint outer race 12 is of one-piece construction including a cup 12a and the shaft portion 12b extending axially from a bottom of the cup 12. The shaft portion 12b is inserted into the axial bore of the hub axle 2A and is fixed thereto by means of a nut member 13 fastened to a free end of the shaft portion 12b. A large diameter base end 12ba of the outer race 12, continued to the cup 12a, is brought into tight contact with an annular inboard end face of the raceway forming member (inner race) 2B, to render the raceway forming member 2B to be axially immovable relative to the hub axle 2A. The hub flange 2a is formed on an outboard end of the hub axle 2a and the vehicle wheel is secured through a brake rotor (not shown) to the hub flange 2a by means of a plurality of bolts 20.

The wheel support bearing assembly also includes a ring-shaped to-be-detected element 9 mounted fixedly on a portion of the inner member 2 between the first and second inner raceways 5. In this first embodiment, the ring-shaped to-be-detected element 9 is mounted on a portion of the outer peripheral surface of the hub axle 2A, which is radially stepped down as at 2b from the outboard first raceway 5 adjacent the hub flange 2a. The portion 2b has an outer diameter smaller than that of the outboard first raceway 5. The inboard end of the hub axle 2A, where the raceway forming member 2B is fixedly mounted, is radially stepped down from the first mounting portion 2b to define a second mounting portion 2c of an outer diameter smaller than that of the first mounting portion 2b.

The ring-shaped to-be-detected element 9 is in the form of a pulsar ring having a magnetic characteristic varying in a direction circumferentially thereof as shown in FIG. 3. More specifically, this ring-shaped to-be-detected element 9 is a multipolar magnet having a plurality of opposite magnetic poles N and S alternating with each other in the circumferential direction. It is, however, to be noted that in place of the multipolar magnet, the ring-shaped to-be-detected element 9 may be made of a magnetic member having a series of serrations formed on an outer periphery thereof.

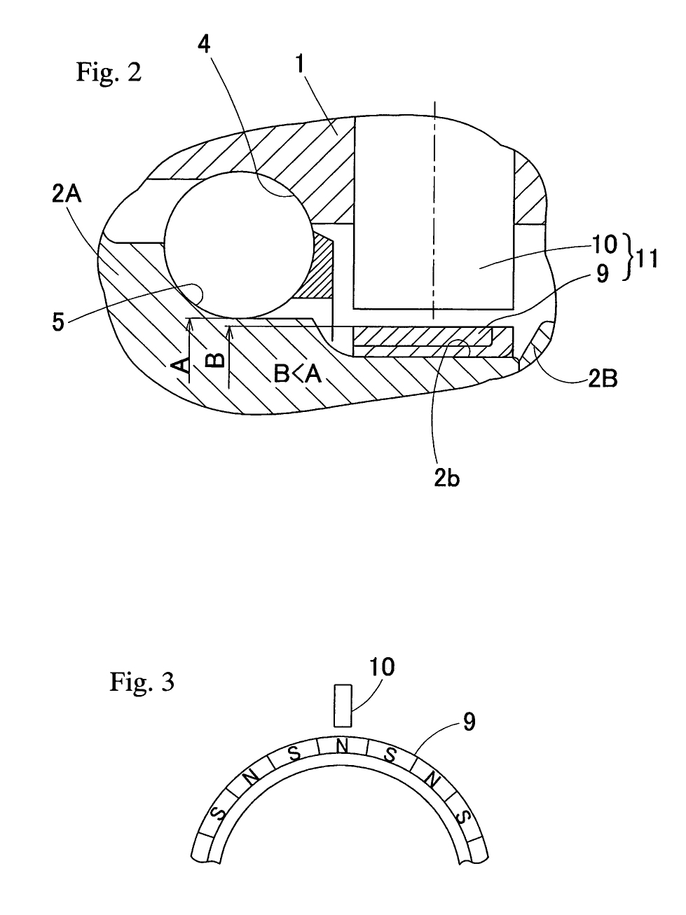

A sensor 10 is mounted on a portion of the inner peripheral surface of the outer member 1 between the first and second outer raceways 4 for detecting the ring-shaped to-be-detected element 9. This sensor 10 is employed in the form of a magnetic sensor such as a Hall element. A combination of the ring-shaped to-be-detected element 9 and the sensor 10 defines a rotation detector 11 for detecting the number of revolutions of the inner member 2 and, hence, that of the vehicle wheel. As shown in FIG. 2 showing an enlarged representation of the circle C of FIG. 1, the outer diameter B of the ring-shaped to-be-detected element 9 fixedly mounted on the first mounting portion 2b of the hub axle 2A is smaller than the diameter A of the circle inscribed by the row of the rolling elements 3 incorporated in the outer raceway 4.

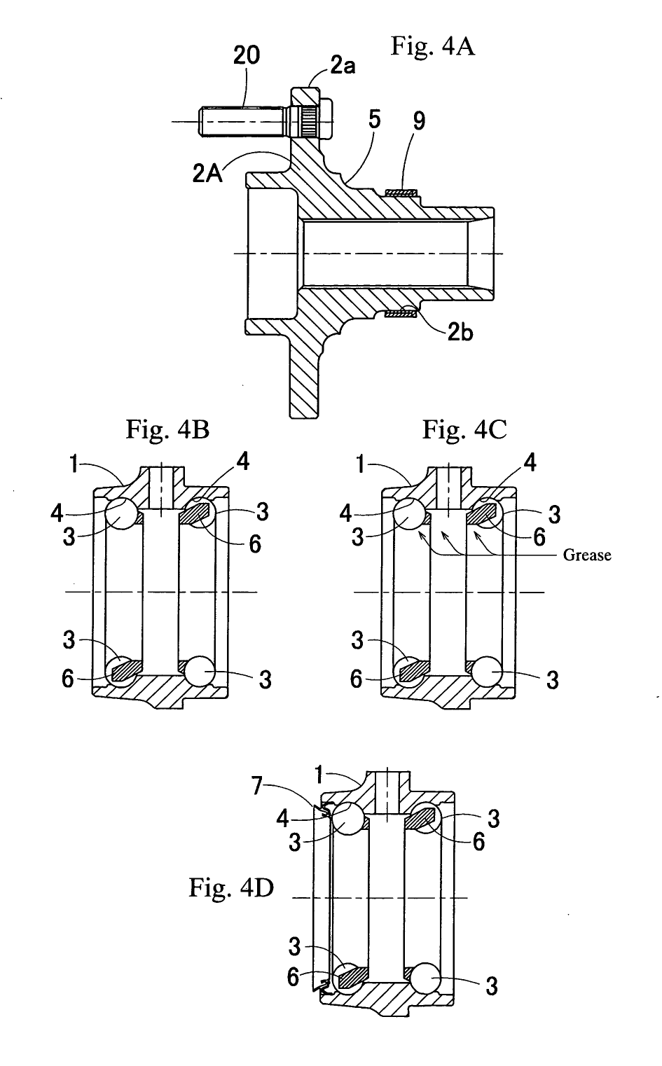

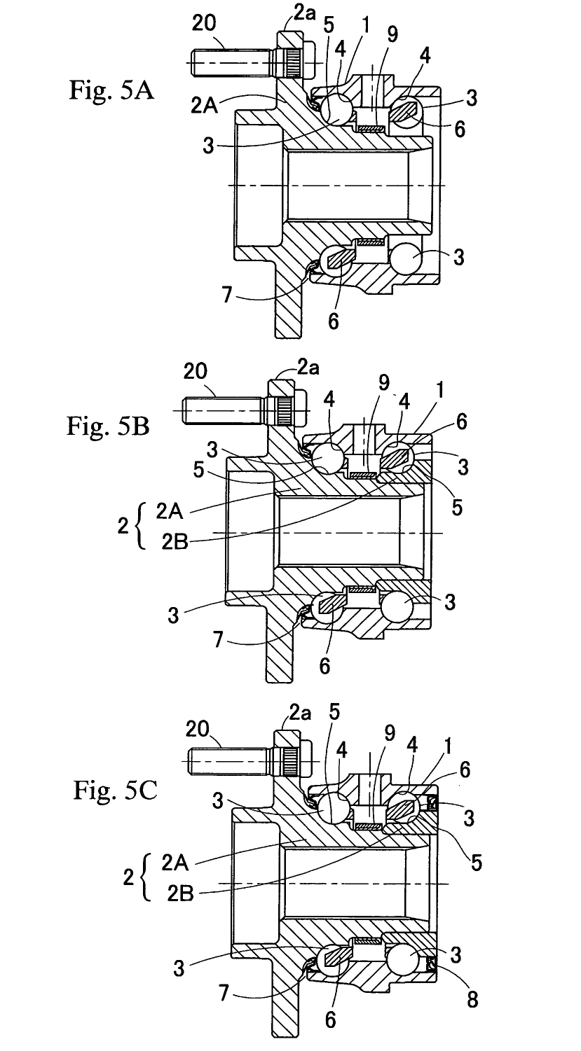

The wheel support bearing assembly of the structure described hereinabove is assembled in the following sequence, which will be described with particular reference to FIGS. 4A to 5C.

(1) In the first place, as shown in FIG. 4A, the ring-shaped to-be-detected element 9 is press-fitted onto the first mounting portion 2b of the hub axle 2A. Since the press-fitting of the element 9 is carried out prior to the incorporation of the inner member 2 into the bore of the outer member 1, any damage to the element 9 such as cracking and/or deformation, which would otherwise result from the press-fitting, can advantageously be detected.

(2) The rolling elements 3 retained by the respective roller retainers 6 are then inserted into the first and second outer raceways 4 of the outer member 1, respectively, as shown in FIG. 4B.

(3) A quantity of grease is applied to outboard and inboard end portions of the inner peripheral surface of the outer member, as shown in FIG. 4C.

(4) The outboard sealing member 7 is subsequently press-fitted into an outboard open end of the outer member 1 as shown in FIG. 4D.

(5) The hub axle 2A having the ring-shaped to-be-detected element 9 is inserted into the bore of the outer member 1 from the outboard side until the outboard first inner raceway 5 is held in position to receive the outboard row of the rolling element 3 as shown in FIG. 5A. When the hub axle 2A is so inserted, the outboard sealing member 7 seals an outboard open end of the annular bearing space.

(6) Thereafter, the raceway forming member (inner race) 2B is press-fitted onto the second mounting portion 2c of the hub axle 2A as shown in FIG. 5B.

(7) Finally, the inboard sealing member 8 is press-fitted into an inboard open end of the outer member 1 to seal the inboard open end of the annular bearing space.

In the wheel support bearing assembly so assembled in the manner described above, since the outer diameter B of the ring-shaped to-be-detected element (the pulsar ring) 9 is, as shown in FIG. 2, smaller than the diameter A of the circle inscribed by the row of the rolling elements 3 incorporated in the first outer raceway 4 in the outer member 1, the hub axle 2A can be inserted into the bore of the outer member 1 in which the rows of the rolling elements 3 have been already incorporated, after the ring-shaped to-be-detected element 9 has been mounted on the mounting portion 2b of the hub axle 2A.

Accordingly, as compared with the assemblage of the prior art wheel support bearing assembly, the number of assembling steps can be reduced by 2 steps. As a result, the number of assembling facilities and the man-hour can advantageously be reduced, resulting in reduction of the manufacturing cost. Also, since the ring-shaped to-be-detected element 9 is press-fitted on the hub axle 2A prior to the hub axle 2A being inserted into the bore of the outer member 1, any damage to the element 9 such as cracking and/or deformation, which would otherwise occur during the press-fitting of the element 9, can easily be detected. Similarly, dusts and dirt generated during the press-fitting of the element 9 can also be removed easily.

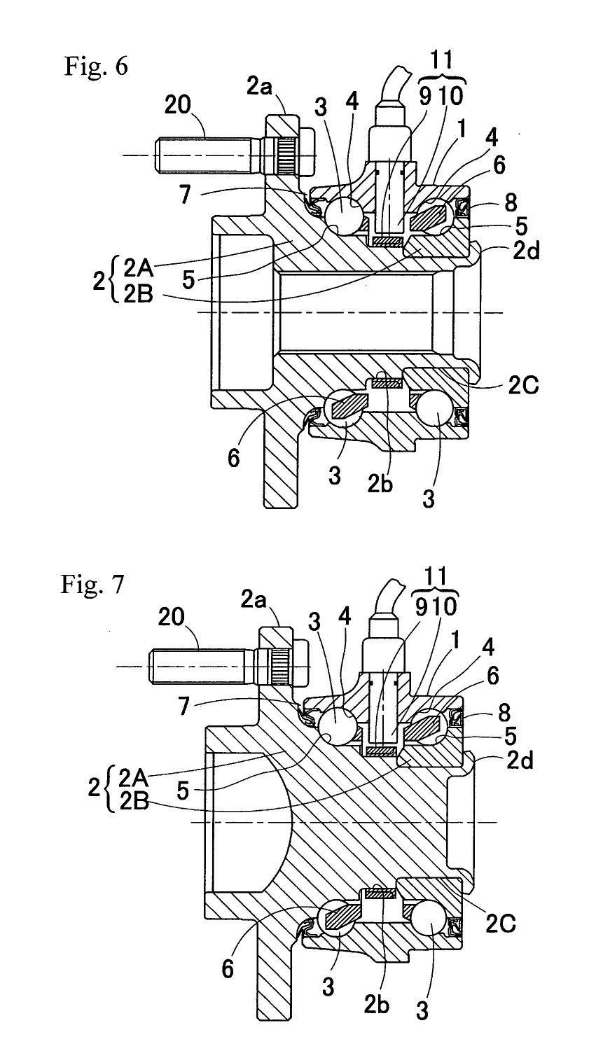

FIG. 6 illustrates the wheel support bearing assembly according to a second preferred embodiment of the present invention. The wheel support bearing assembly shown therein is substantially similar to that of the first embodiment, except that the inboard end of the hub axle 2A is formed with a flange-like portion 2d, which is staked radially outwardly to fix the raceway forming member 2B in position immovable axially relative to the hub axle 2A.

Other structural features of the wheel support bearing assembly of the second embodiment are substantially similar to those of the wheel support bearing assembly of the first embodiment and, therefore, the details thereof are not reiterated for the sake of brevity.

The wheel support bearing assembly according to a third preferred embodiment of the present invention is shown in FIG. 7. This wheel support bearing assembly is designed to support a vehicle driven wheel and is substantially similar to that according to the first embodiment, except that the hub axle 2A employed therein is a solid member in contrast to the hollow hub axle 2A employed in the first embodiment. The raceway forming member (inner race) 2B shown in FIG. 7 is fixed in position by the flange-like staked portion 2d integral with the inboard end of the hub axle 2A.

Other structural features of the wheel support bearing assembly of the third embodiment are substantially similar to those of the wheel support bearing assembly of the first embodiment and, therefore, the details thereof are not reiterated for the sake of brevity.

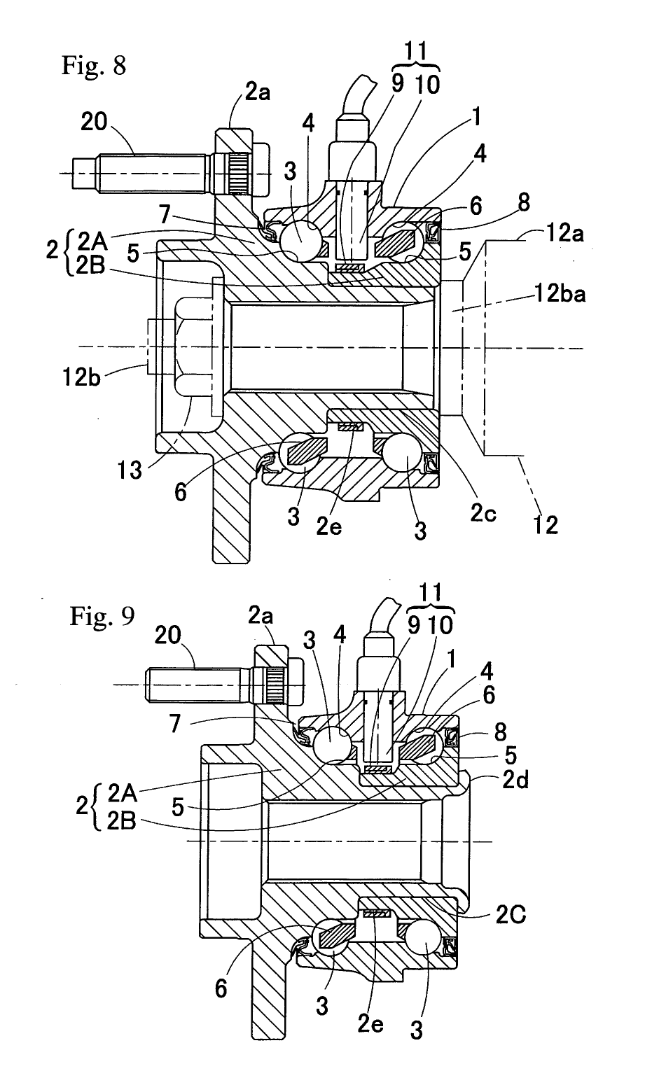

Referring now to FIG. 8, the wheel support bearing assembly according to a fourth preferred embodiment of the present invention will be described. This wheel support bearing assembly is substantially similar to that of the first embodiment, except that a portion of the raceway forming member 2B between the first and second inner raceways 5 is formed as a mounting portion 2e on which the ring-shaped to-be-detected element 9 is fixedly mounted. This mounting portion 2e of the raceway forming member 2B is radially stepped down from the inboard second raceway 5 and has an outer diameter smaller than that of the inboard second raceway 5. The element 9 mounted on the mounting portion 2e is thus axially fixed immovable in position between the first and second inner raceways 5. The raceway forming member 2B employed therein is an inner race and the ring-shaped to-be-detected element 9 employed therein is a pulsar ring.

Other structural features of the wheel support bearing assembly of the fourth embodiment are substantially similar to those of the wheel support bearing assembly of the first embodiment and, therefore, the details thereof are not reiterated for the sake of brevity.

The wheel support bearing assembly according to a fifth preferred embodiment of the present invention is shown in FIG. 9. The wheel support bearing assembly shown in FIG. 9 is substantially similar to that of the fourth embodiment shown in FIG. 8, except that the inboard end of the hub axle 2A is formed with the flange-like portion 2d, which is staked radially outwardly to fix the raceway forming member 2B in position immovable axially relative to the hub axle 2A.

Other structural features of the wheel support bearing assembly of the fifth embodiment are substantially similar to those of the wheel support bearing assembly of the fourth embodiment and, therefore, the details thereof are not reiterated for the sake of brevity.

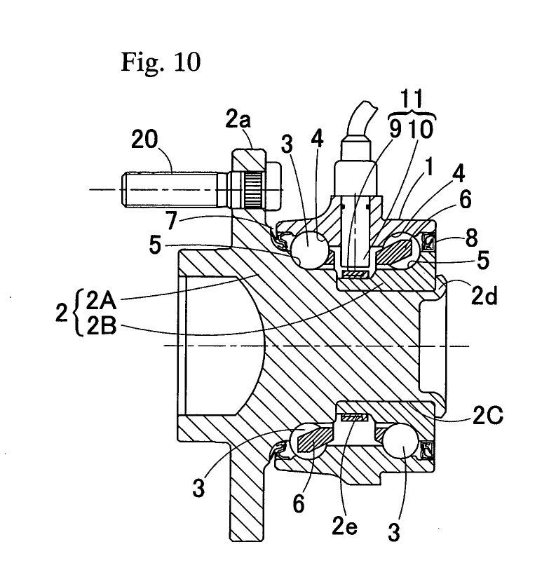

In a sixth preferred embodiment of the present invention shown in FIG. 10, the wheel support bearing assembly shown therein is designed to support a vehicle driven wheel. This wheel support bearing assembly is substantially similar to that of the fourth embodiment shown in FIG. 8, except that the hub axle 2A is a solid member in contrast to the hollow hub axle 2A employed in the wheel support bearing assembly of the first embodiment. The raceway forming member (inner race) 2B shown in FIG. 10 is fixed in position by the flange-like staked portion 2d integral with the inboard end of the hub axle 2A.

Other structural features of the wheel support bearing assembly of the sixth embodiment are substantially similar to those of the wheel support bearing assembly of the fourth embodiment and, therefore, the details thereof are not reiterated for the sake of brevity.

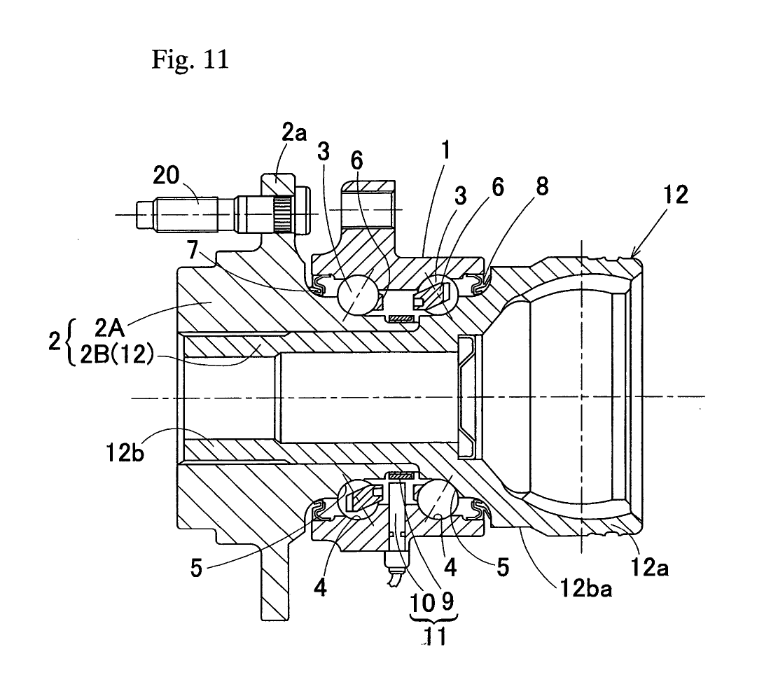

In a seventh preferred embodiment of the present invention shown in FIG. 11, the wheel support bearing assembly is applied to a fourth generation type. The wheel support bearing assembly shown in FIG. 11 is substantially similar to that according to the first embodiment, except that, in place of the use of the raceway forming member 2B forming a part of the inner member 2, the outer race 12 of the constant speed universal joint, having the shaft portion 12b press-fitted into the bore of the hub axle 2A, is concurrently utilized as a raceway forming member. The second inner raceway 5 on the inboard side of the bearing assembly is formed on an outer surface of the large diameter base end 12ba of the shaft portion 12b that is continued to the cup 12a. Also, the inboard sealing member 8 is press-fitted into the outer member 1 and assumes a position as interposed between the outer surface of the base end 12ba of the outer race 12, when the shaft portion 12b is subsequently inserted into and splined to the hub axle 2A.

Other structural features of the wheel support bearing assembly of the seventh embodiment are substantially similar to those of the wheel support bearing assembly of the first embodiment and, therefore, the details thereof are not reiterated for the sake of brevity.

Even when the outer race 12 of the constant speed universal joint concurrently serves as a raceway forming member where the inboard raceway groove 5 is formed, as is the case with the first embodiment using the raceway forming member 2B, the assemblability can be increased by making the outer diameter of the ring-shaped to-be-detected element 9 smaller than the diameter of the circle inscribed by the outboard row of the rolling elements 3.

In any one of the foregoing embodiments of the present invention, the ring-shaped to-be-detected element 9 has been described as a pulsar ring utilized for the detection of the rotation, but it may be utilized for the detection of, for example, a load, torque or strain.

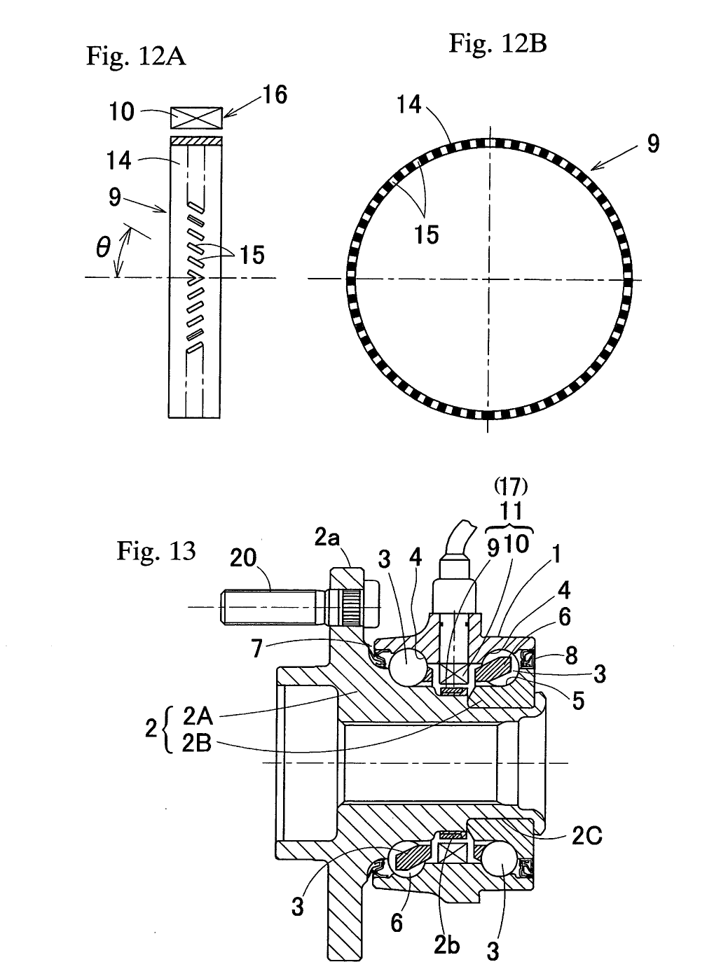

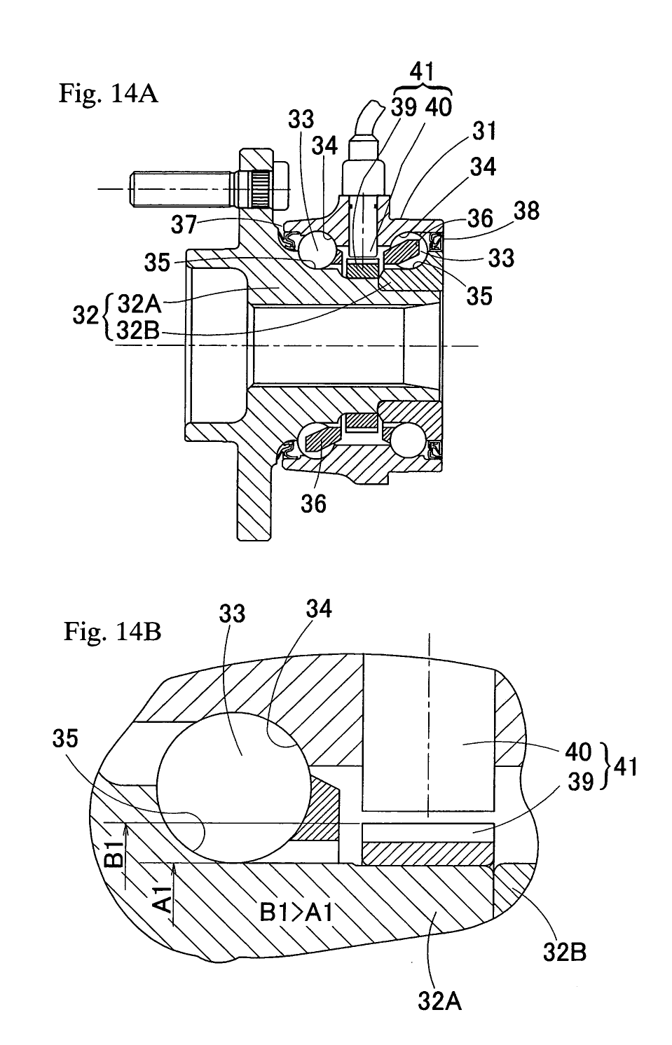

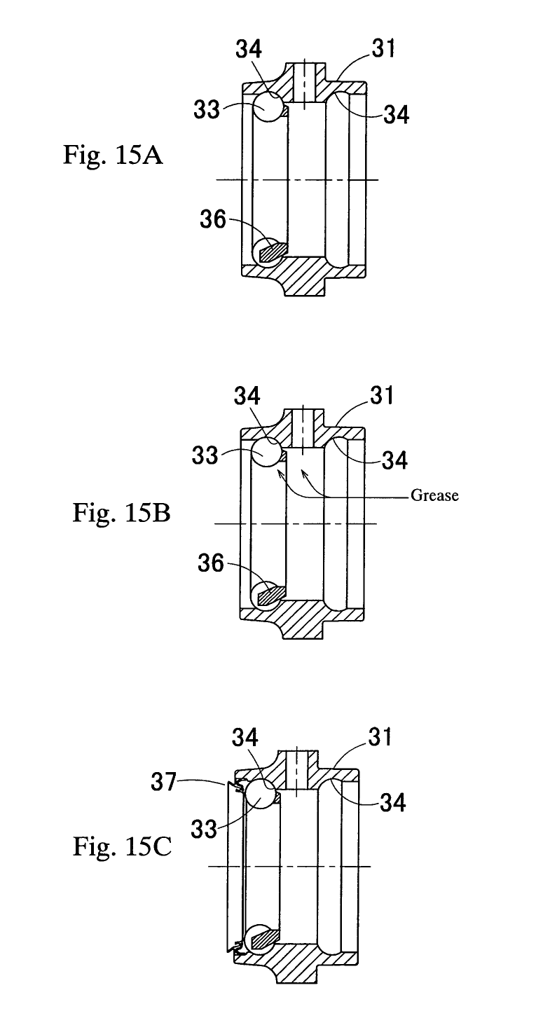

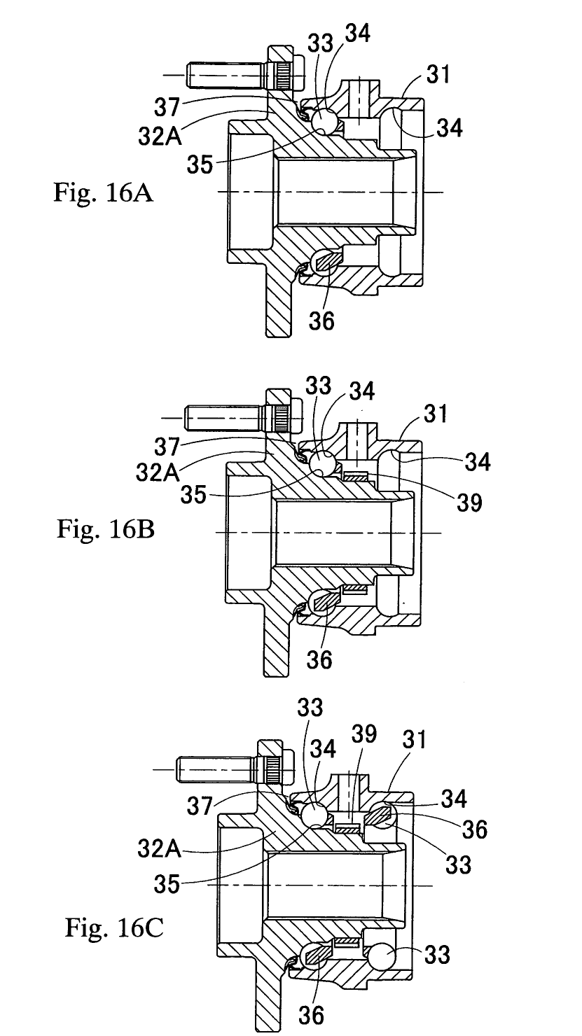

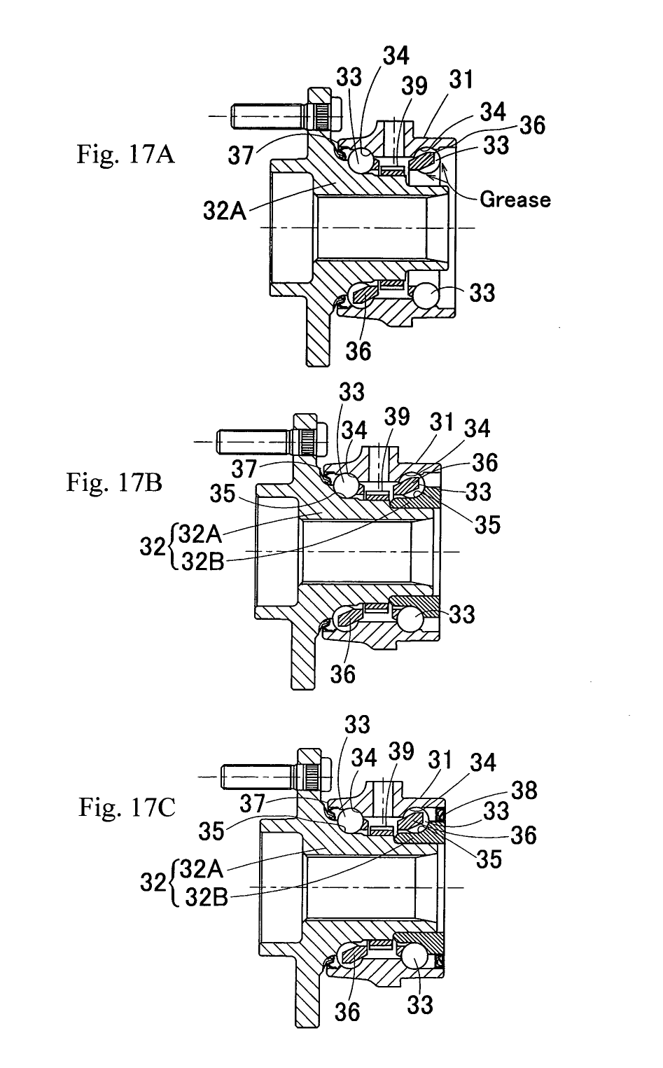

By way of example, as shown in FIGS. 12A and 12B, the ring-shaped to-be-detected element 9 may be in the form of a cylindrical element 14 made of a magnetostrictive material and having a plurality of slots 15 defined circumferentially thereof. Each of the slots 5 inclines at a predetermined angle é relative to the axis of rotation of the ring-shaped to-be-detected element 9. In this case, a torque detecting element such as a coil for detecting the change in magnetic characteristic of the cylindrical element 14 can be used as the sensor 10, so that the cylindrical element 14 and the torque detecting element can cooperate with each other to define a torque detector 16 for detecting the torque acting on the inner member 2.

Also, in the first embodiment of the present invention shown in FIG. 1, the ring-shaped to-be-detected element 9 mounted on the inner member 2 may be, as shown in FIG. 13, employed in the form of a rotor of an electric generator 17, in which case the sensor 10 mounted on the outer member 1 is employed in the form of a stator coil of the electric generator 17. By so designing, the electric generator 17 can concurrently serve not only as an electric generator but also a rotation detector for detecting the rotational speed of the vehicle wheel.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

1. A wheel support bearing assembly, which comprises:
an outer member having an inner peripheral surface formed with two outer raceways;
an inner member positioned inside the outer member, with an annular bearing space defined between it and the outer member, and having inner raceways formed therein in alignment with the respective outer raceways, the inner member including a hub axle, which has a radially outwardly extending hub flange formed therein for securement of a vehicle wheel thereto, and a raceway forming member mounted fixedly on an inboard end of the hub axle, the inner raceways being formed on an outer peripheral surface of the hub axle and an outer peripheral surface of the raceway forming member, respectively;
rows of rolling elements rollingly accommodated within the annular bearing space and sandwiched between the outer raceways and the inner raceways, respectively;
a ring-shaped element to be detected mounted fixedly on a portion of the inner member between the inner raceways and having an outer diameter smaller than the diameter of the circle inscribed by the row of the rolling elements then assembled into the raceway in the outer member; and
a sensor, for detecting the to-be-detected element, fixedly mounted on a corresponding portion of the outer member between the outer raceways.

2. The wheel support bearing assembly as claimed in claim 1, wherein the ring-shaped to-be-detected element comprises a pulsar ring having a magnetic characteristic varying in a direction circumferentially thereof and the sensor comprises a magnetic sensor.

3. The wheel support bearing assembly as claimed in claim 1, wherein the ring-shaped to-be-detected element is made of a magnetostrictive material and wherein the sensor comprises a torque detecting element for detecting a torque, working on the inner member, by detecting change in magnetic characteristic of the ring-shaped to-be-detected element.

4. The wheel support bearing assembly as claimed in claim 1, wherein the raceway forming member comprises an inner race which forms a dedicated member for defining the raceway.

5. The wheel support bearing assembly as claimed in claim 1, wherein the raceway forming member comprises an outer race of a constant velocity universal joint and wherein the inner member is of a structure, in which a shaft portion of the outer race of the constant speed universal joint is press-fitted into the hub axle, with the inner raceways defined in an outer peripheral surface of the hub axle and an outer peripheral surface of a base end of the shaft portion of the outer race of the constant speed universal joint, respectively.
